(19) United States
(12) Patent Application Publication
(10) Pub. No.: US 2016/0269847 A1
(43) Pub. Date: Sep. 15, 2016

(54) METHOD AND APPARATUS FOR DOWNMIXING A MULTICHANNEL SIGNAL AND FOR UPMIXING A DOWNMIX SIGNAL

(71) Applicant: STORMINGSWISS GMBH, Morges (CH)

(72) Inventor: Clemens Par, Cinuos-chel (CH)

(21) Appl. No.: 15/026,739

(22) PCT Filed: Oct. 2, 2014
(86) PCT No.: PCT/EP2014/071154

§ 371 Date: May 27, 2016

(30) Foreign Application Priority Data
Oct. 2, 2013 (CH) 1696/13
Oct. 9, 2013 (CH) 01727/13
Feb. 28, 2014 (CH) 0369/14
May 15, 2014 (CH) 0743/14
Jul. 1, 2014 (CH) 0995/14

(51) Int. Cl. H04S 5/00

(52) U.S. Cl. CPC H04S 5/005; H04S 2400/05

(57) ABSTRACT

Method for upmixing a downmix signal having a first channel and a second channel into an upmix signal, having the steps of:
carrying out a correlation comparison in order to determine correlated signal components of the first and second channels of the downmix signal, wherein a first channel of the upmix signal is determined on the basis of the first channel of the downmix signal, a second channel of the upmix signal is determined on the basis of the second channel of the downmix signal and a third channel of the upmix signal is determined on the basis of the correlated signal components;
determining at least one fourth channel of the upmix signal by inversely coding the first, second or third channel of the upmix signal.

The invention relates to a method and an apparatus for increasing the number of channels in a downmix signal by means of correlation comparison and pseudostereophony, in particular inverse coding.

Audio multichannel signals require an amount of memory that is proportional to the number of channels for the purpose of transmission and storage. Therefore, the amount of memory is often reduced by reducing the number of channels in what is known as a downmix. To reconstruct the original audio multichannel signal, there are various methods in the prior art.

Firstly, it is known practice to take two channels and produce an additional channel, situated between the two channels, on the basis of the signal components with a common occurrence in the two channels. To this end, a correlation comparison is performed that is used to extract the correlated signal components, and in this way the additional channel is ascertained on the basis of the correlated signal components.

Alternatively, what are known as pseudostereophonic methods can be used that ascertain an additional channel from one channel of the downmix signal.

A special case of pseudostereophonic methods is inverse coding (a solution to inverse problems for three dimensional audio signals), which takes geometric parameters as a basis for computing the split of the signal components between a left and a right channel from a monosignal. Suitable geometric parameters are e.g. the angle between a sound source and a main axis of a microphone and/or a fictitious acceptance angle of the microphone and/or a fictitious left acceptance angle of the microphone and/or a fictitious right acceptance angle and/or a directional characteristic of the microphone. These parameters can either by transmitted together with the downmix signal or can be chosen permanently on the basis of the parameters used in the downmix, or they can also be stipulated as default values. Inverse coding is disclosed in WO2009138205, for example.

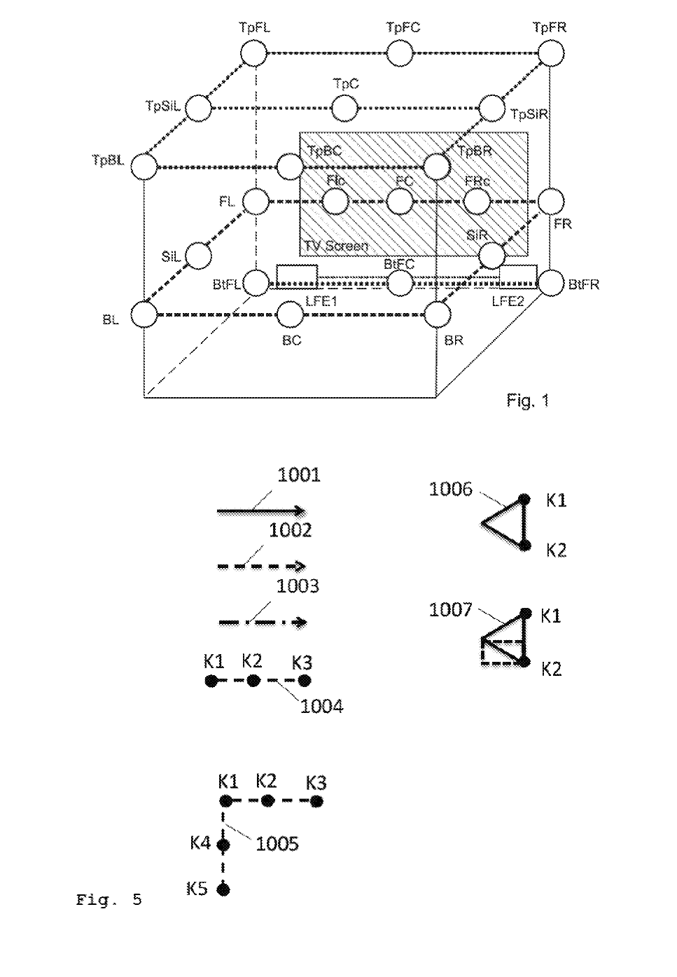

NHK 22.2 is a standard for “Audio Surround Sound” with 22 channels and with two low-frequency base channels (also called Hamasaki 22.2). Most popular standards for “Audio Surround Sound” can be derived from this standard. FIG. 1 schematically shows the positions of the loudspeakers associated with the 24 channels of a multichannel signal according to Hamasaki 22.2. For a downmix of such a multichannel signal having 24 channels, there are now enumerable options for combining the known methods such as correlation comparison and the numerous pseudostereophonic methods in order to restore the 24 channels. Similar problems also arise for the restoration of audio multichannel signals in other standards or audio formats on the market from a downmix.

It is therefore an object of the invention to find an optimum method for producing an upmix signal in order to obtain an upmix signal of optimum quality.

The object is achieved by the independent claims.

Further embodiments are described in the dependent claims.

Various embodiments of the present invention are described by way of example below, reference being made to the following drawings:

FIG. 1 shows an NHK-22.2 arrangement.

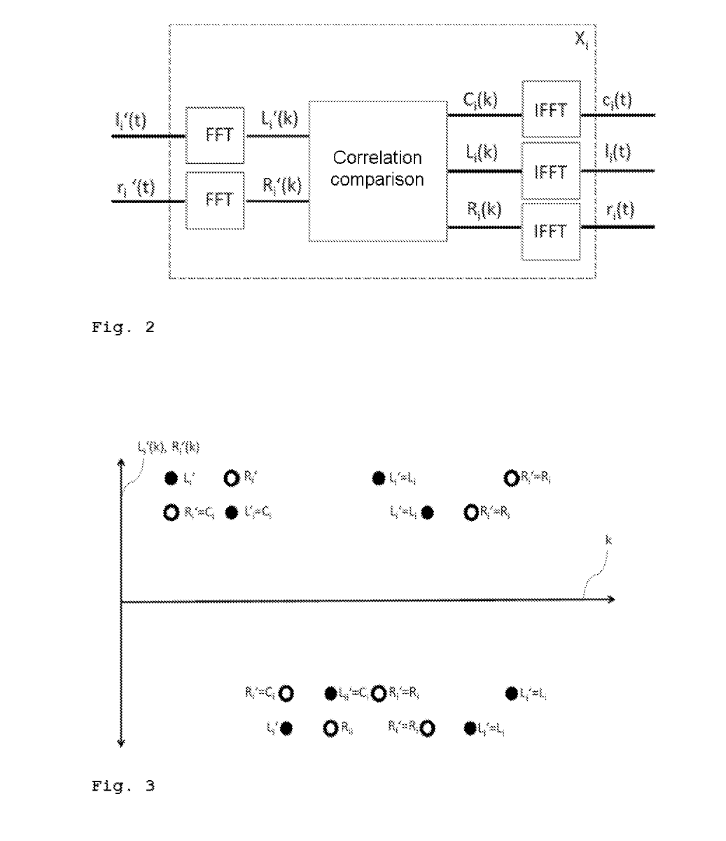

FIG. 2 shows an exemplary embodiment of a correlation comparison.

FIG. 3 shows the spectral arithmetic sign comparison for a correlation comparison.

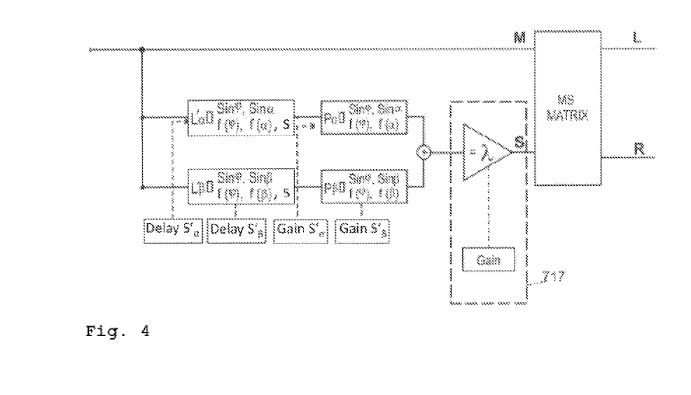

FIG. 4 shows an exemplary embodiment of inverse coding.

FIG. 5 shows the symbols used in the subsequent figures.

FIG. 6 shows a first exemplary embodiment of the downmix.

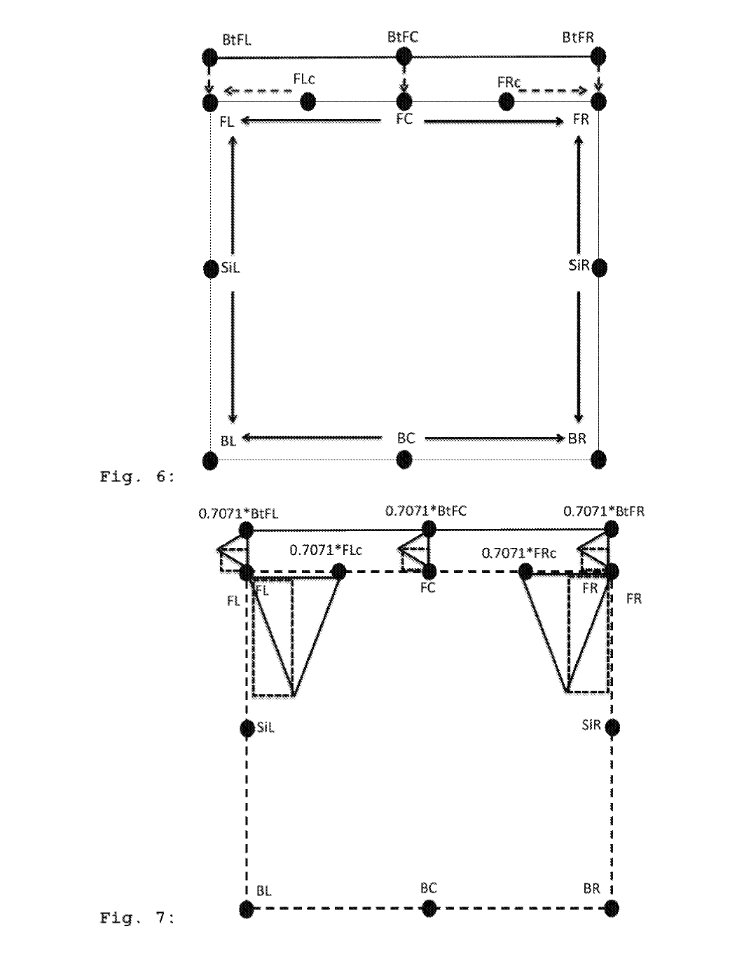

FIG. 7 shows a first exemplary embodiment of the upmix.

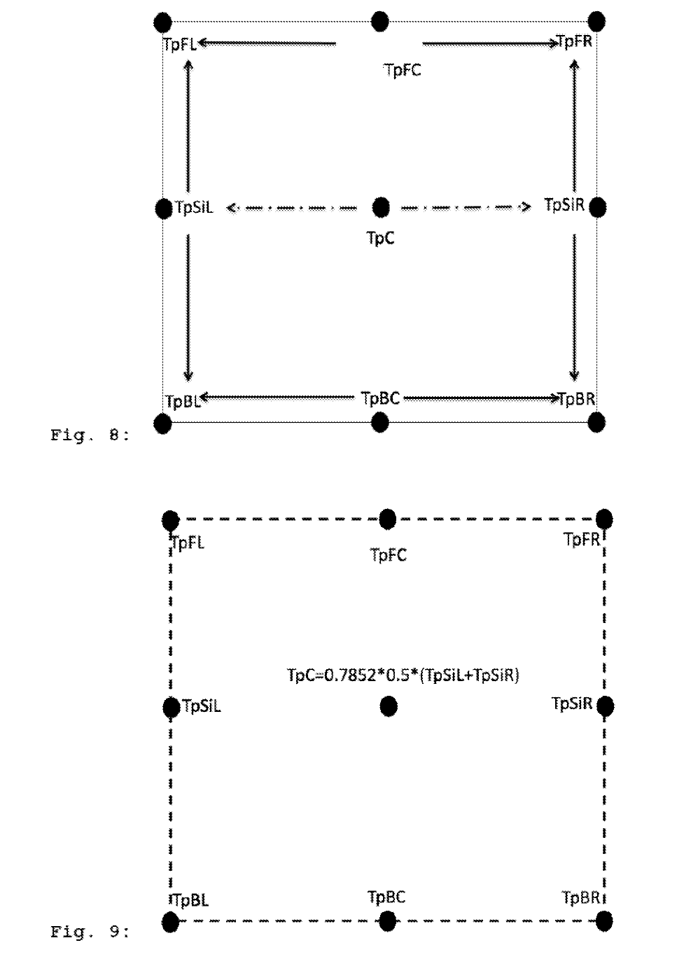

FIG. 8 shows a second exemplary embodiment of the downmix.

FIG. 9 shows a second exemplary embodiment of the upmix.

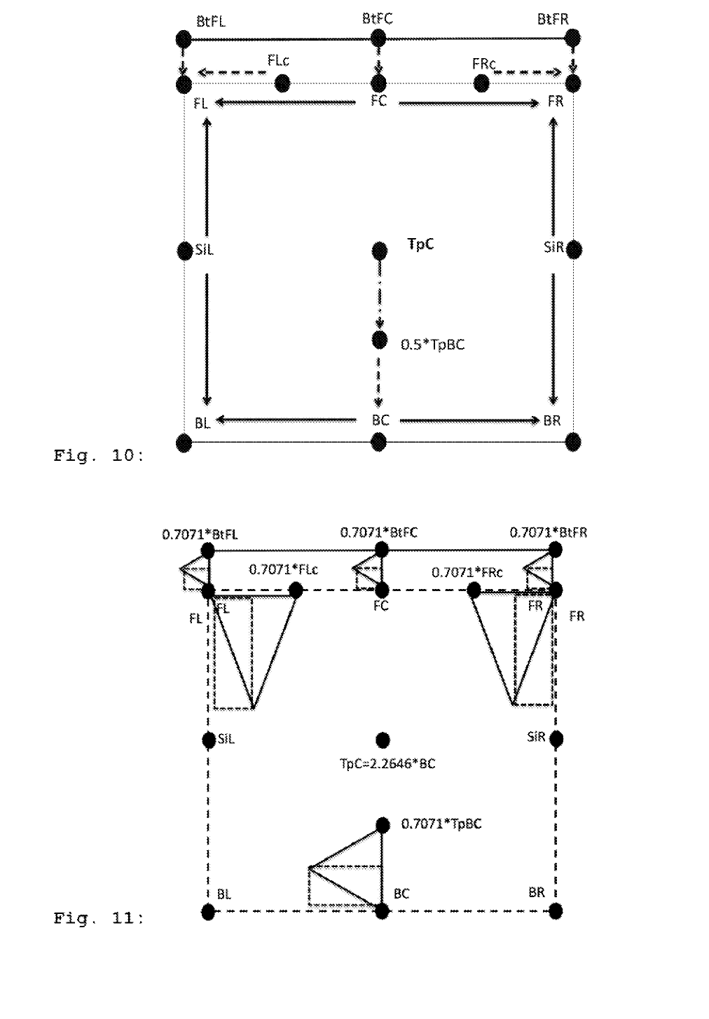

FIG. 10 shows a fifth exemplary embodiment of the downmix.

FIG. 11 shows a fifth exemplary embodiment of the upmix.

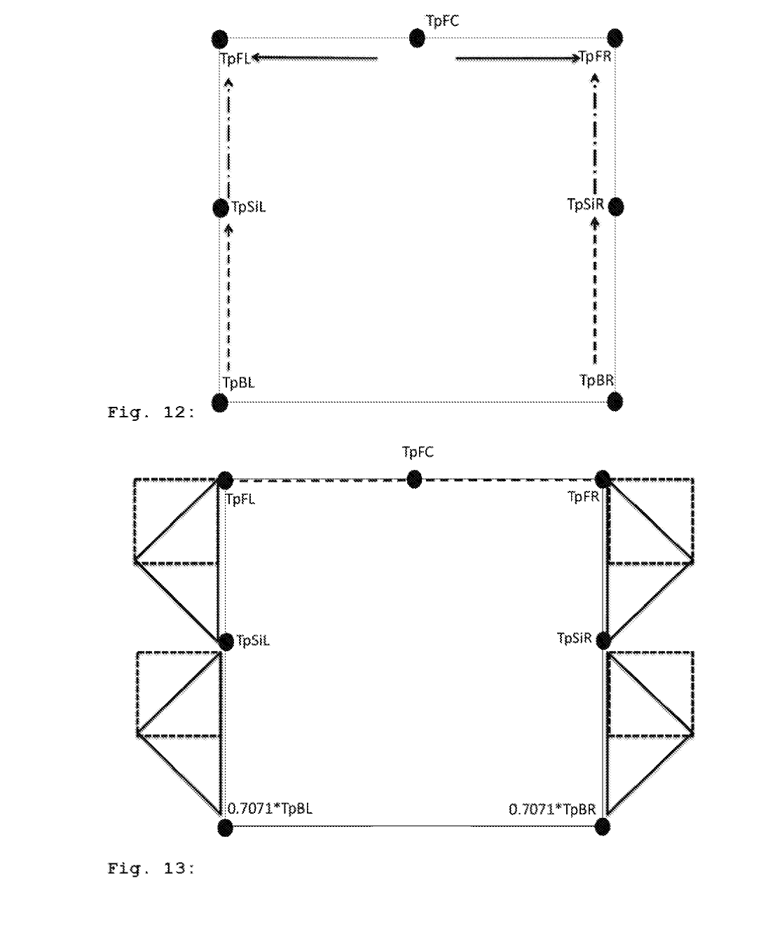

FIG. 12 shows a sixth exemplary embodiment of the downmix.

FIG. 13 shows a sixth exemplary embodiment of the upmix.

FIG. 14 shows an eighth exemplary embodiment of the downmix.

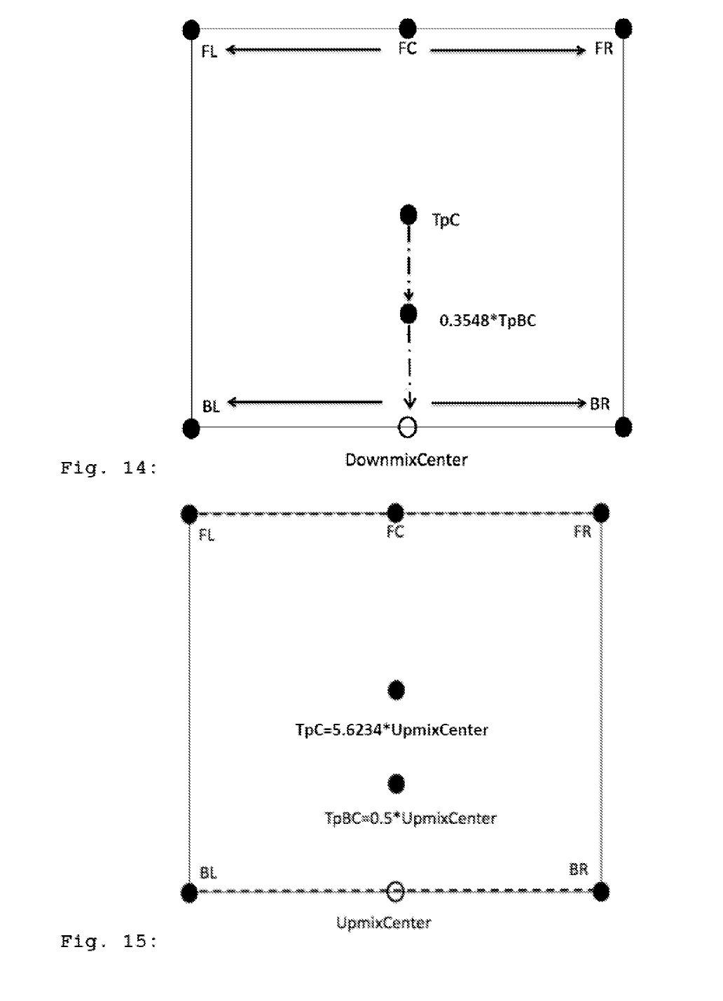

FIG. 15 shows an eighth exemplary embodiment of the upmix.

FIG. 16 shows a tenth exemplary embodiment of the downmix.

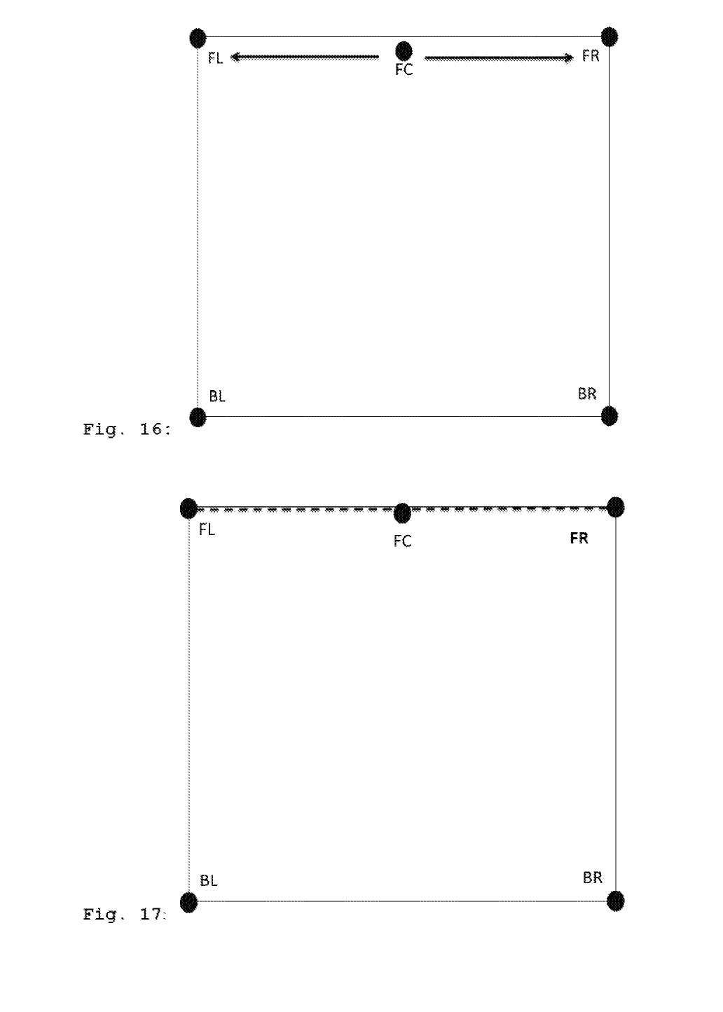

FIG. 17 shows a tenth exemplary embodiment of the upmix.

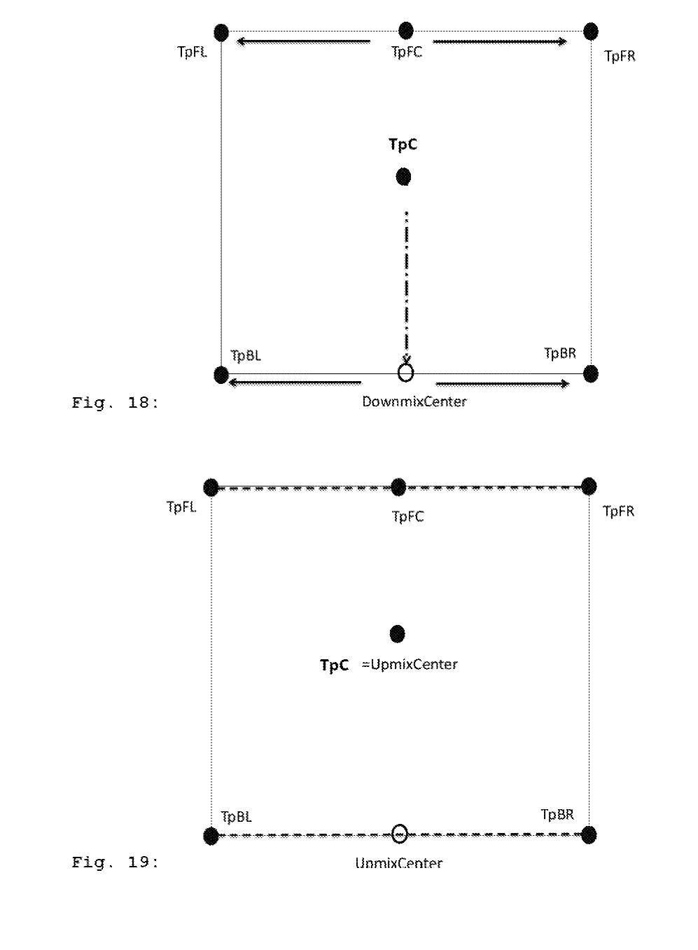

FIG. 18 shows an eleventh exemplary embodiment of the downmix.

FIG. 19 shows an eleventh exemplary embodiment of the upmix.

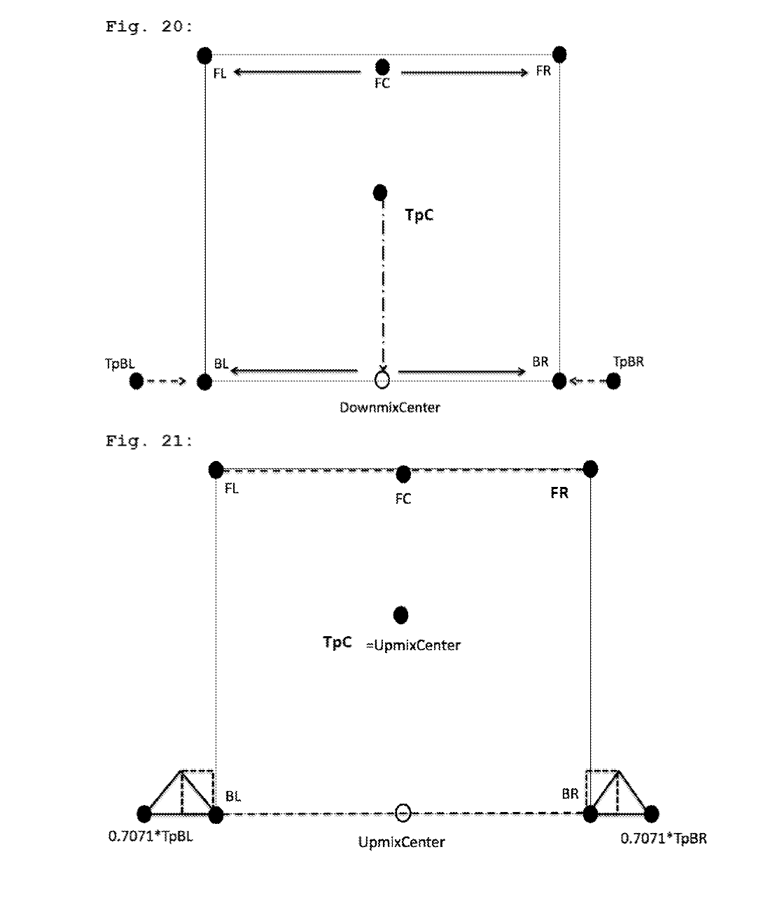

FIG. 20 shows a thirteenth exemplary embodiment of the downmix.

FIG. 21 shows a thirteenth exemplary embodiment of the upmix.

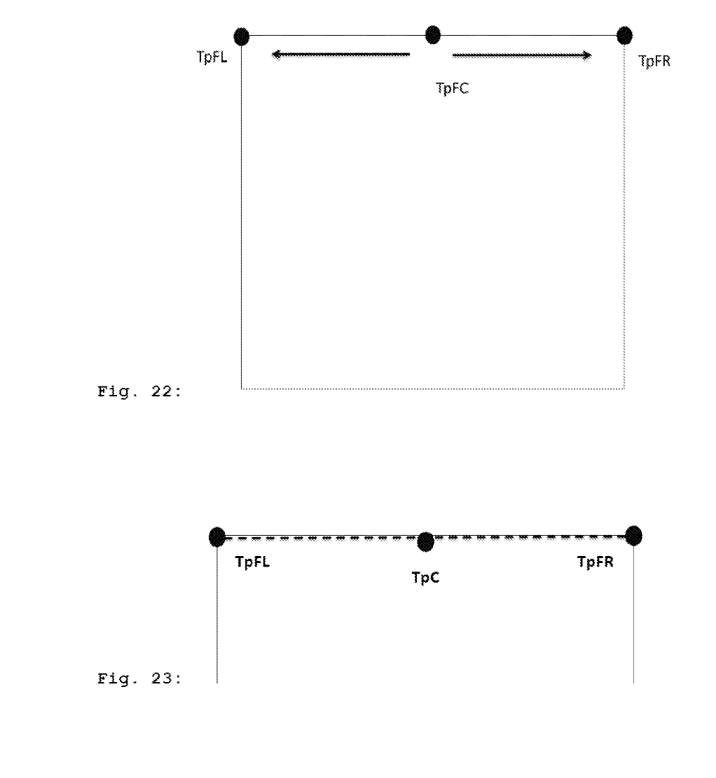

FIG. 22 shows a fourteenth exemplary embodiment of the downmix.

FIG. 23 shows a fourteenth exemplary embodiment of the upmix.

FIG. 1 shows an NHK 22.2 arrangement from which it is possible to derive a multiplicity of standards and formats on the market for “Audio Surround Sound”. For reasons of consistency, however, the same nomenclature of the NHK 22.2 standard will always be used so as not to cause confusion. The text below always refers only to channel positions, this meaning the position of a loudspeaker associated with the channel. In this context, the positions in FIG. 1 are intended to be neither exact nor restrictive, but rather only to represent the approximate relative position of the loudspeakers in relation to one another. The NHK 22.2 system has three horizontal layers that are referred to as the bottom layer, the middle layer and the top layer. Many other standards for “Audio Surround Sound” have two—usually the middle and top layers—or three of these layers and are intended to be denoted as such for all standards.

The individual channel positions of the NHK 22.2 system are briefly introduced below.

In this context, the middle layer has the following channel positions (abbreviation between parentheses): a front left channel (FL), a front center left channel (FLc), a front center channel (FC), a front center right channel (FRc), a front right channel (FR), a side right channel (SiR), a rear right channel (BR), a rear center channel (BC), a rear left channel (BL) and a side left channel (SiL).

In this context, the top layer has the following channel positions (abbreviation between parentheses): a front left channel (TpFL), a front center channel (TpFC), a front right channel (TpFR), a side right channel (TpSiR), a rear right channel (TpBR), a rear center channel (TpBC), a rear left channel (TpBL) and a side left channel (TpSiL).

The bottom layer has the following channels (abbreviations between parentheses): a front left channel (BtFL), a front center channel (BtFC), a front right channel (BtFR).

In addition, there are also a first low-frequency channel (LFE1) and a second low-frequency channel (LFE2), which are each intended for a subwoofer.

When methods and/or apparatuses for upmixing are presented for particular channels of the NHK 22.2 system below, these methods can be applied not only for NHK 22.2 but rather for all standards and formats on the market that contain these channels. When a front right channel is referred to below, this is not just limited to FR but also includes TpFR, FRc and BtFR, which are all front right channels, unless it is clear from the context that only the channel FR can be meant. This applies analogously for all other channels.

The technologies used for the downmix and the upmix will be presented briefly below.

There are many possibilities for performing the aforementioned correlation comparison. Without limiting the invention, the following method for determining the correlated signals and/or the individual signals of two input signals is used by way of preference below. A method for extracting at least one output signal from two input signals by: providing first frequency-dependent input signal components and second frequency-dependent input signal components for a multiplicity of frequencies; comparing the arithmetic signs of the first frequency-dependent input signal component and the second frequency-dependent input signal component of a frequency in the multiplicity of frequencies; determining at least one from a first frequency-dependent individual signal component of a first individual signal, a second frequency-dependent individual signal component of a second individual signal and a common frequency-dependent signal component of the frequency in the multiplicity of frequencies on the basis of the arithmetic sign comparison; determining the at least one output signal on the basis of the first frequency-dependent individual signal components of the multiplicity of frequencies and/or the second frequency-dependent individual signal components of the multiplicity of frequencies and/or the common (also referred to as “correlated”) frequency dependent signal components of the multiplicity of frequencies. FIG. 2 shows a diagram for such a preferred correlation comparison. To this end, the input signals lᵢ′ (t) and rᵢ′ (t) to be subjected to the correlation comparison, e.g. channels from the downmix or signals obtained therefrom, are subjected to a Fourier transformation if Lᵢ′ (k) and Rᵢ′ (k) are not already in a Fourier space representation. The correlation comparison has an arithmetic sign comparison for the spectral values Lᵢ′ (k) and Rᵢ′ (k) of the two input signals for each frequency k. If the real parts of Re(Lᵢ′ (k)) and Re(Rᵢ′ (k)) both have the same arithmetic sign, then Re(Cᵢ (k)) corresponds to that real part of Re(Lᵢ′ (k)) and Re(Rᵢ′ (k)) whose absolute magnitude value is smaller or that is closer to the zero. The real part of the individual signal Re(Lᵢ (k)) and Re(Rᵢ (k)) that is associated with the absolutely larger real part of Re(Lᵢ′ (k)) and Re(Rᵢ′ (k)) corresponds to the difference in the two real parts (so that the arithmetic sign of the real part of the individual signal corresponds to the real part, associated with these, of the input signal). The other real part of the two individual signals is zero. This is shown in FIG. 3 in cases 1 to 4. If the real parts of Re(Lᵢ′ (k)) and Re(Rᵢ′ (k)) have different arithmetic signs, then the real part of the correlated signal Re(Cᵢ (k))=0 and the following applies for the real parts of the individual first and second signals:

Re(Lᵢ(k))=Re(Lᵢ′(k)) and Re(Rᵢ(k))=Re(Rᵢ′(k)).

This is shown in FIG. 3 in cases 5 to 8. The same is also performed for the imaginary part of the correlated signal Im(Cᵢ (k)) and the individual signals Im(Lᵢ (k)) and Im(Rᵢ (k)) and for each frequency k. If the correlated signal Cᵢ(k) and the individual signals Lᵢ (k) and Rᵢ (k) are needed in the time domain, then they are transformed back to the time domain using an inverse Fourier transformation (IFFT). Depending on the application, this method can be used to determine one, two or three signals from Lᵢ (k), Rᵢ (k) and Cᵢ (k).

The correlation comparison described is theoretically exact if steady-state signals are involved, which is often not the case for audio signals, however. The error between the actual correlated signal and the correlated signal ascertained by the correlation comparison for non-steady-state signals is referred to as the residual Δ. If the residual for each correlation comparison is now transmitted as well, then each channel reduced by the downmix is again replaced by a channel for the residual, and hence no data reduction is obtained. Various technologies for correcting the residual for the upmix are described below.

Residual mean value correction is based on the idea that production of the downmix signal, which involves a first channel K1 being mixed onto a second and a third channel K2 and K3, and a fourth channel K4 being mixed onto a fifth channel K5 and a sixth channel K6, involves two correlation comparisons being performed in order to reconstruct the first and fourth channels K1′ and K4′. For each correlation comparison, the residual Δ1 and Δ4 is determined, e.g. as a result of

Δ1=0.5*(K1′−K1) and Δ4=0.5*(K4′−K4),

and an averaged residual ΔM is computed therefrom. In this case, the sixth channel K6 may also correspond to the third channel K3, or the first channel K1 may correspond to the fourth channel K4. This principle can be generalized for three or four or more correlation comparisons. In this case, a downmix apparatus is used to determine and average the residuals for the correlation comparisons that are also performed in the upmix apparatus. Hence, as a result of the transmission of an averaged residual ΔM, it is possible to correct a multiplicity of channels determined by correlation comparison in the upmix. It is also possible for different subgroups of correlation comparisons to be formed and for an averaged residual ΔMU to be transmitted for each subgroup. In each subgroup, all correlated signals ascertained from the correlation comparisons are corrected by the averaged residual ΔMU of this subgroup. If the residual is computed as described above, the corrected correlated signal ck is preferably implemented by

ck=c+2*ΔM,

where c is the correlated/common signal determined from the correlation comparison and ΔM is the averaged residual.

A similar situation applies for the second and a third channel K2 and K3 and for the fifth channel K5 and the sixth channel K6, which, on the basis of the same correlation comparison, have the same residual Δ1 or Δ4, which are able to be corrected by the averaged residual ΔM. The corrected signals lk and rk are preferably implemented by

lk=1−ΔM

and

rk=r−ΔM.

The correction can be performed in a frequency domain or in the time domain. For details, reference is made to the unpublished Swiss patent application CH2013/1727, the content of which for residual mean value correction is included here by way of reference.

If exemplary embodiments with upmix channels obtained by means of correlation comparison are used below, then it is possible for the upmix channels obtained not to be corrected or to be corrected by the technology described or a further technology for residual correction.

Inverse coding is the special form of a pseudostereophonic method that can be used to parametrically compute an optimum split for signal components of a monochannel over two channels. In one exemplary embodiment, these parameters are transmitted along with the downmix signal and chosen in optimum fashion during the downmix on the basis of the mixed channel. However, it is also possible for these parameters to be chosen with the downmix on a fixed basis and for these parameters chosen on a fixed basis to be found for the upmix. It is also possible for optimum fixed parameters to be chosen in the upmix. It is also possible for the parameters to be chosen in the upmix on the basis of the nature of the downmix signal channel that is intended to be subjected to inverse coding. Suitable parameters are the angle between a sound source and a main axis of a microphone, an acceptance angle of the microphone, a fictitious left acceptance angle of the microphone, a fictitious right acceptance angle and/or a directional characteristic for the input signal. Preferably, at least a first gain for the inverse coding and at least a first delay for the inverse coding are determined on the basis of a sound source and a main axis of a microphone, possibly additionally on the basis of an acceptance angle of the microphone, particularly a fictitious left acceptance angle of the microphone and a fictitious right acceptance angle and/or a directional characteristic. A first intermediate signal and a second intermediate signal are determined on the basis of the at least one delay and the at least one gain of the inverse coding, on the first channel and the second channel of the upmix are determined on the basis of the first intermediate signal and the second intermediate signal. In one exemplary embodiment, the inverse coding is designed to take at least one weighting factor as a basis for producing the first channel and the second channel in each case by means of weighted addition and/or weighted subtraction of the first and second intermediate signals. In one exemplary embodiment, two delays are corrected in the inverse coding on the basis of the angle between the sound source and the main axis of the microphone, the left fictitious acceptance angle, the right fictitious acceptance angle and a directional characteristic, and these two delays are possibly additionally corrected by a common time factor (s). FIG. 4 shows an example of inverse coding of this type. Details pertaining to the implementation of inverse coding can be found in the applications EP1850629 or WO2009138205 or WO2011009649 or WO2011009650 or WO2012016992 or WO2012032178, the content of which pertaining to inverse coding is included herewith by way of reference.

A further possibility for reducing the volume of data is what is known as masking. This filters out frequencies that are inaudible to the ear from the audio channels. This is performed both for single channels (monomasking) and for channel pairs (stereo masking). An example of masking is “Unified Speech and Audio Coding v2” (USAC v2).

Various exemplary embodiments are described below in relation to the downmixing of a multichannel signal having k channels into a downmix signal having m<k channels and upmixing of the downmix signal into an upmix signal having n channels, where m<n<=k is true for these exemplary embodiments. Clever combination of the processes described also allows m<k<=n, which is easy to understand provided that one or more output channels are additionally subjected to inverse coding, for example. These downmix and upmix processes are shown schematically in the figures that follow.

FIG. 5 shows the symbols used in the figures that follow. The solid arrow 1001 shows the addition of a channel, weighted with 0.5 (−6 dB), that is situated on the arrow origin side to a channel that is situated on the arrow direction side in order to produce a channel of the downmix signal from the two cited channels. The same is true for the dashed arrow 1002, which involves the use of a weighting factor of 0.7071 (−3 dB) instead of the weighting factor 0.5 (−6 dB). The same is true for the dash-dot arrow 1003, which involves the use of a weighting factor of 1 (0 dB) instead of the weighting factor 0.5 (−6 dB). The straight dashed line 1004 between the channels K1 and K3 means that an upmix signal is formed from a downmix signal having the channels K1 and K3 on the basis of the three channels K1, K3 and K2, K2 and/or K1 and/or K3 being ascertained by means of a correlation comparison. If two correlation comparisons 1005 are performed at a common channel K1, then the channel K1 of the upmix signal is corrected by the channel K2 obtained by means of correlation comparison or by the channel K4 obtained by means of correlation comparison. The triangle 1006 means that an upmix signal having the first channel K1 and a second channel K2 is obtained from an existing channel K1 or K2 of a downmix signal by means of inverse coding of the existing channel K1 or K2 of the downmix signal. The triangle with the dashed rectangle 1007 of K2 means that an additional channel K1 of an upmix signal is obtained from an existing channel K2 of a downmix signal by means of inverse coding of the existing channel K2 of the downmix signal. The existing channel K2 is also used for the upmix signal, or processed further to form further channels of the upmix signal.

In a first exemplary embodiment, a multichannel signal having k=13 channels is downmixed in a downmix apparatus into a downmix signal having m=4 channels and then upmixed again in an upmix or coding apparatus into an upmix signal having n=13 channels. In this case, the multichannel signal, the downmix signal and the upmix signal may possibly also have additional channels.

FIG. 6 shows the downmix of the channels BtFL, BtFC, BtFR, FL, FLc, FC, FRc, FR, SiR, BR, BC, BL and SiL of the multichannel signal. The four channels of the downmix signal are determined as follows:

FL′=FL+0.7071*FLc+0.7071*BtFL+0.5*(0.7071*BtFC+FC)+0.5*SiL

FR′=FR+0.7071*FRc+0.7071*BtFR+0.5*(0.7071*BtFC+FC)+0.5*SiR

BR′=BR+0.5*BC+0.5*SiR

BL′=BL+0.5*BC+0.5*SiL.

This means that a front left downmix channel FL′ is formed from a linear combination of the channels FL, FLc, BtFL, BtFC, FC and SiL, a front right downmix channel FR′ is formed from a linear combination of the channels FR, FRc, BtFR, BtFC, FC and SiR, a rear right downmix channel BR′ is formed from a linear combination of the channels BR, BC and SiR, and a rear left downmix channel BL′ is formed from a linear combination of the channels BL, BC and SiL. The four channels of the downmix can additionally have the volume of data reduced by means of stereo masking, for example by means of USAC v2 encoding, and therefore result in two “Channel Pair Elements” (CPEs).

FIG. 7 shows the upmix of the channels BtFL, BtFC, BtFR, FL, FLc, FC, FRc, FR, SiR, BR, BC, BL and SiL of the upmix signal from the channels FL′, FR′, BL′ and BR′ of the downmix signal. In this case, four correlation comparisons

K(FL′,FR′)→FC,(FL″,FR″)

K(FR′,BR′)→SiR,(FR″,BR″)

K(BR′,BL′)→BC,(BR″,BL″)

K(BL′,FL′)→SiL,(BL″,FL″)

are first of all performed, which result in the center channels FC, SiL, SiR, BC. The corner channels FL″, FR″, BR″ and BL″ could be determined on the basis of the individual signal components from the correlation comparisons. These center channels (and the corner channels FL″, FR″, BR″, BL″ resulting from these correlation comparisons or the corner channels FL, FR, BR, BL that in turn result from these channels) could, in one exemplary embodiment, be corrected by a mean residual that is transmitted along with the downmix signal. The corner channels FL, FR, BR, BL are obtained by means of correction of the corresponding channels of the downmix signal having the two adjacent center channels, i.e. for FL′, FC and SiL are used for correction, etc. Alternatively, these corner channels FL, FR, BR, BL could also be determined directly from the correlation comparisons as the corresponding individual signals (for example by correcting a corner channel FL″, FR″, BR″, BL″ that comes from such a correlation comparison by that adjacent center channel that does not come from this correlation comparison). The inverse coding of the channel FL with different parameter sets P(BtFL) and P(FLc) results in:

BtFL=0.7071*Inv(FL,P(BtFL)) and

FLc=0.7071*Inv(FL,P(FLc)).

The inverse coding of the channel FR with different parameter sets P(BtFR) and P(FRc) results in:

BtFR=0.7071*Inv(FR,P(BtFR)) and

FRc=0.7071*Inv(FR,P(FRc)).

The inverse coding of the channel FC with the parameter set P(BtFC) results in:

BtFC=0.7071*Inv(FC,P(BtFC)).

As can be seen, the output from the inverse coding is also multiplied by a factor that in this case is chosen as 0.7071 (−3 dB), but can also be chosen differently. Hence, the 13 channels of the upmix signal can be determined on the basis of BtFL, BtFC, BtFR, FL′ or FL″, FLc, FC, FRc, FR′ or FR″, SiR, BR′ or BR″, BC, BL′ or BL″ and SiL from the four channels of the downmix signal. If the downmix signal contains FL and FR as a subset, then FC, BtFL, FLc, BtFC, FRc, BtFR or subsets thereof can be determined therefrom as described if these channels have been mixed to FL and FR in the downmix.

In a second exemplary embodiment, a multichannel signal having k=9 channels is downmixed in a downmix apparatus into a downmix signal having m=4 channels and then upmixed again in an upmix or coding apparatus into an upmix signal having n=9 channels. In this case, the multichannel signal, the downmix signal and the upmix signal may possibly also have additional channels.

FIG. 8 shows the downmix of the channels TpFL, TpFC, TpFR, TpSiR, TpBR, TpBC, TPBL, TpSiL and TpC of the multichannel signal. The four channels of the downmix signal are determined as follows:

TpFL′=TpFL+0.5*(TpC+TpSiL+TpFC)

TpFR′=TpFR+0.5*(TpC+TpSiR+TpFC)

TpBL′=TpBL+0.5*(TpC+TpSiL+TpBC)

TpBR′=TpBR+0.5*(TpC+TpSiR+TpBC).

This means that a top front left downmix channel TpFL′ is formed from a linear combination of the channels TpFL, TpFC, TpC and TpSiL, a top front right downmix channel TpFR′ is formed from a linear combination of the channels TpFR, TpFC, TpC and TpSiR, a top rear right downmix channel TpBR′ is formed from a linear combination of the channels TpBR, TpBC, TpC and TpSiR, and a top rear left downmix channel TpBL′ is formed from a linear combination of the channels TpBL, TpBC, TpC and TpSiL. The four channels of the downmix can additionally have the volume of data reduced by means of stereo masking, for example by means of USAC v2 encoding, and therefore result in two “Channel Pair Elements” (CPEs).

FIG. 9 shows the upmix of the channels TpFL, TpFC, TpFR, TpSiR, TpBR, TpBC, TpBL, TpSiL and TpC of the upmix signal from the channels TpFL′, TpFR′, TpBL′ and TpBR′ of the downmix signal. In this case, four correlation comparisons

K(TpFL′,TpFR′)→TpFC,(TpFL″,TpFR″)

K(TpFR′,TpBR′)→TpSiR,(TpFR″,TpBR′)

K(TpBR′,TpBL′)→TpBC,(TpBR″,TpBL′)

K(TpBL′,TpFL′)→TpSiL,(TpBL″,TpFL″)

are first of all performed, which result in the center channels TpFC, TpSiL, TpSiR, TpBC. These center channels (and the corner channels TpFL″, TpFR″, TpBR″, TpBL″ resulting from these correlation comparisons or the corner channels TpFL, TpFR, TpBR, TpBL that in turn result from these channels) could, in one exemplary embodiment, be corrected by a mean residual that is transmitted along with the downmix signal. The corner channels TpFL, TpFR, TpBR, TpBL are obtained by means of correction of the corresponding channels of the downmix signal TpFL′, TpFR′, TpBR′, TpBL′ with the two adjacent center channels, i.e. for TpFL′, correction is performed using TpFC and TpSiL, etc. Alternatively, these corner channels TpFL, TpFR, TpBR, TpBL could also be determined directly from the correlation comparisons as the corresponding individual signals (for example by correcting a corner channel TpFL″, TpFR″, TpBR″, TpBL″ coming from such a correlation comparison by that adjacent center channel that does not come from this correlation comparison). The TpC is obtained on the basis of the sum of TpSiL and TpSiR, e.g. by means of multiplication by a weighting factor. For example, TpC=0.7852*0.5(TpSiL+TpSiR) allows determination thereof.

In a third exemplary embodiment, a multichannel signal having k=22 channels (NHK 22.0 arrangement) is downmixed in a downmix apparatus into a downmix signal having m=8 channels and then upmixed again in an upmix or coding apparatus into an upmix signal having n=22 channels. In this case, the multichannel signal, the downmix signal and the upmix signal may possibly have additional channels. This is achieved by combining the first and second exemplary embodiments.

In a tenth exemplary embodiment, a multichannel signal having k=5 channels is downmixed in a downmix apparatus into a downmix signal having m=4 channels and then upmixed again in an upmix or coding apparatus into an upmix signal having n=5 channels. In this case, the multichannel signal, the downmix signal and the upmix signal may possibly also have additional channels. The multichannel signal has the channels FR, FC, FL, BL and BR.

FIG. 16 shows the downmix from the tenth exemplary embodiment. In this regard, the channel FC of the multichannel signal has equal components (preferably weighted with 0.5) mixed to FR and FL in order to obtain the channels FR′=FR+0.5*FC and FL′=FL+0.5*FC. Hence, the downmix signal has the channels FR′, FL′, BR and BL. FIG. 17 shows the upmix of the channels FL, FC and FR of the upmix signal from FL′ and FR′ of the downmix signal. In this case, a correlation comparison

K(FL′,FR′)→FC,(FL,FR)

is performed. The channels FR and FL of the upmix signal could also be determined on the basis of FR′ corrected with FC and FL′ corrected with FC. Hence, an upmix signal having the channels FR, FC, FL, BR and BL is obtained. Preferably, channel pairs BR-BL and/or FR′-FL′ of the downmix signal are subjected to stereo masking, for example USAC v2 encoding, and therefore result in two “Channel Pair Elements” (CPEs).

In a fourth exemplary embodiment, a multichannel signal having k=14 channels is downmixed in a downmix apparatus into a downmix signal having m=8 channels and then upmixed again in an upmix or coding apparatus into an upmix signal having n=14 channels. In this case, the multichannel signal, the downmix signal and the upmix signal may possibly have additional channels. The multichannel signal has the channels FR, FC, FL, BL, BR, TpFL, TpFC, TpFR, TpSiR, TpBR, TpBC, TpBL, TpSiL and TpC. The channels TpFL, TpFC, TpFR, TpSiR, TpBR, TpBC, TpBL, TpSiL and TpC are, as shown in the second exemplary embodiment and in FIG. 8, downmixed into the downmix signals TpFL′, TpFR′, TpBL′ and TpBR′. From the channels TpFL′, TpFR′, TpBL′ and TpBR′ of the downmix signal, the channels TpFL, TpFC, TpFR, TpSiR, TpBR, TpBC, TpBL, TpSiL and TpC of the upmix signal are determined, as shown in the second exemplary embodiment and in FIG. 9. The channels FR, FC, FL, BL and BR are, as shown in the tenth exemplary embodiment and in FIG. 16, downmixed into the downmix signals FR′, FL′, BL and BR. From the channels FR′, FL′, BL and BR of the downmix signal, the channels FR, FC, FL, BL and BR of the upmix signal are determined, as shown in the tenth exemplary embodiment and in FIG. 17.

In a fifth exemplary embodiment, a multichannel signal having k=22 channels (NHK 22.0 arrangement) is downmixed in a downmix apparatus into a downmix signal having m=6 channels and then upmixed again in an upmix or coding apparatus into an upmix signal having n=22 channels. In this case, the multichannel signal, the downmix signal and the upmix signal may possibly also have additional channels.

FIG. 10 shows the downmix of the channels TpC, TpBC, BtFL, BtFC, BtFR, FL, FLc, FC, FRc, FR, SiR, BR, BC, BL and SiL of the multichannel signal. The four channels of the downmix signal are determined as follows:

FL′=FL+0.7071*FLc+0.7071*BtFL+0.5*(0.7071*BtFC+FC)+0.5*SiL

FR′=FR+0.7071*FRc+0.7071*BtFR+0.5*(0.7071*BtFC+FC)+0.5*SiR

BR′=BR+0.5*(SiR+0.7071*((TpC*0.5*TpBC)+BC))

BL′=BL+0.5*(SiL+0.7071*((TpC*0.5*TpBC)+BC)).

This means that the front left downmix channel FL′ and the front right downmix channel FR′ are determined as in the first exemplary embodiment in FIG. 6. The rear left downmix channel BL′ and the rear right downmix channel BR′ are determined as in the first exemplary embodiment in FIG. 6, with the difference that additionally signal components of TpBC and TpC are contained in BR′ and BL′.

FIG. 11 shows the upmix of the channels TpC, TpBC, BtFL, BtFC, BtFR, FL, FLc, FC, FRc, FR, SiR, BR, BC, BL and SiL of the upmix signal from the channels FL′, FR′, BL′ and BR′ of the downmix signal. As in the first exemplary embodiment in FIG. 7, the channels BtFL, BtFC, BtFR, FL, FLc, FC, FRc, FR, SiR, BR, BC, BL and SiL of the upmix signal are determined from the four channels of the downmix signal. In addition, the inverse coding of the channel BC is now performed with the parameter set P(TpBC):

TpBC=0.7071*Inv(BC,P(TpBC)).

The TpC is determined from a gain of the channel BC. The gain is preferably determined with a gain factor of greater than one, or even better greater than two, and particularly with TpC=2.2646*BC. It is therefore possible for the 15 channels of the upmix signal to be determined on the basis of TpC, TpBC, BtFL, BtFC, BtFR, FL′ or FL″, see above, FLc, FC, FRc, FR′ or FR″, SiR, BR′ or BR″, BC, BL′ or BL″ and SiL from the four channels of the downmix signal. If the downmix signal contains FL and FR as a subset, then it is possible, as described, for FC, BtFL, FLc, BtFC, FRc, BtFR or subsets thereof to be determined therefrom if these channels have been mixed to FL and FR in the downmix.

In a sixth exemplary embodiment, a multichannel signal having k=7 channels is downmixed in a downmix apparatus into a downmix signal having m=2 channels and then upmixed again in an upmix or coding apparatus into an upmix signal having n=7 channels. In this case, the multichannel signal, the downmix signal and the upmix signal may possibly also have additional channels.

FIG. 12 shows the downmix of the channels TpFL, TpFC, TpFR, TpSiR, TpBR, TpBL and TpSiL of the multichannel signal. The two channels of the downmix signal are determined as follows:

TpFL′=TpFL+0.5*TpFC+TpSiL+0.7071*TpBL

TpFR′=TpFR+0.5*TpFC+TpSiR+0.7071*TpBR.

This means that a top front left downmix channel TpFL′ is formed from a linear combination of the channels TpFL, TpFC, TpBL and TpSiL, and a top front right downmix channel TpFR′ is formed from a linear combination of the channels TpFR, TpFC, TpBR and TpSiR. The two channels of the downmix can additionally have the volume of data reduced by means of stereo masking, for example by means of USAC v2 encoding, and therefore result in one “Channel Pair Element” (CPE).

FIG. 13 shows the upmix of the channels TpFL, TpFC, TpFR, TpSiR, TpBR, TpBL and TpSiL of the upmix signal from the channels TpFL′ and TpFR′ of the downmix signal. In this case, a correlation comparison

K(TpFL′,TpFR′)→TpFC,(TpFL,TpFR)

is first of all performed, which results in the center channel TpFC and the corner channels TpFR and TpFL. The channels TpFR and TpFL of the upmix signal could alternatively also be determined on the basis of TpFR′ corrected with TpFC and TpFL′ corrected with TpFC. Hence, a first subset of the upmix signal having the channels TpFR, TpFC, TpFL is obtained.

The inverse coding of the channel TpFL with the parameter set P(TpSiL) results in:

TpSiL=Inv(TpFL,P(TpSiL)).

Subsequently, the inverse coding of the channel TpSiL is performed with the parameter set P(TpBL) and results in:

TpBL=0.7071*Inv(TpSiL,P(TpBL)).

The inverse coding of the channel TpFR with the parameter set P(TpSiR) results in:

TpSiR=Inv(TpFR,P(TpSiR)).

Subsequently, the inverse coding of the channel TpSiR is performed with the parameter set P(TpBR) and results in:

TpBR=0.7071*Inv(TpSiR,P(TpBR)).

Hence, correlation comparison obtains the channel TpFC and the channels TpFL and TpFR of the upmix signal, and inverse coding obtains the channels TpSiR, TpBR, TpBL and TpSiL.

In a seventh exemplary embodiment, a multichannel signal having k=22 channels (NHK 22.2 arrangement) is downmixed in a downmix apparatus into a downmix signal having m=6 channels and then upmixed again in a upmix or coding apparatus into an upmix signal having n=22 channels. In this case, the multichannel signal, the downmix signal and the upmix signal may possibly also have additional channels. This is achieved by combining the fifth and sixth exemplary embodiments.

In an eighth exemplary embodiment, a multichannel signal having k=7 channels is downmixed in a downmix apparatus into a downmix signal having m=4 channels and then upmixed again in an upmix or coding apparatus into an upmix signal having n=7 channels. In this case, the multichannel signal, the downmix signal and the upmix signal may possibly also have additional channels.

FIG. 14 shows the downmix of the channels FL, FC, FR, BR, BL, TpBC and TpC of the multichannel signal. The four channels of the downmix signal are determined as follows:

FL′=FL+0.5*FC

FR′=FR+0.5*FC

BR′=BR+0.5*(TpC+0.3548*TpBC)

BLY=BL+0.5*(TpC+0.3548*TpBC).

This means that a front left downmix channel FL′ is formed from a linear combination of the channels FL and FC, a front right downmix channel FR′ is formed from a linear combination of the channels FR and FC, a rear right downmix channel BR′ is formed from a linear combination of the channels BR, TpC and TpBC, and a rear left downmix channel BL′ is formed from a linear combination of the channels BL, TpC and TpBC. The four channels of the downmix signal can additionally have the volume of data reduced by means of stereo masking of channel pairs, for example USAC v2 encoding, and therefore result in two “Channel Pair Elements” (CPEs).

FIG. 15 shows the upmix of the channels FL, FC, FR, BR, BL, TpBC and TpC of the upmix signal from the channels FL′, FR′, BL′ and BR′ of the downmix signal. In this case, two correlation comparisons

K(FL′,FR′)→FC,(FL,FR)

K(BL′,BR′)→UpmixCenter,(BL,BR)

are first of all performed, which result in the center channel FC and also the channels FL and FR, and the center channel UpmixCenter and also the channels BR and BL, the channel UpmixCenter being only an intermediate signal and not forming a rear center channel (BC) of the upmix signal. The channels FR and FL or the channels BR and BL of the upmix signal could alternatively also be determined on the basis of FR′ corrected with FC and FL′ corrected with FC and also on the basis of BR′ corrected with BC and BL′ corrected with BC. Hence, a first subset of the upmix signal having the channels FR, FC, FL and also having the channels BR, BC, BL is obtained.

The channels TpC and TpBC are determined on the basis of the intermediate signal UpmixCenter, e.g. by means of

TpC=5.6234*UpmixCenter

TpBC=0.5*UpmixCenter.

Preferably, the TpC is determined by means of a gain for the upmix center of greater than one or greater than two or greater than three or greater than four or greater than five and the TpBC is determined by means of an attenuation with a gain factor of less than 1. Hence, correlation comparison of FR′ and FL′ obtains the channels FR, FC and FL of the upmix signal and correlation comparison of BL′ and BR′ obtains the channels BR, BL, TpC and TpBC.

In a ninth exemplary embodiment, a multichannel signal having k=14 channels is downmixed in a downmix apparatus into a downmix signal having m=6 channels and then upmixed again in an upmix or coding apparatus into an upmix signal having n=14 channels. In this case, the multichannel signal, the downmix signal and the upmix signal may possibly also have additional channels. The multichannel signal has the channels FR, FC, FL, BL, BR, TpFL, TpFC, TpFR, TpSiR, TpBR, TpBC, TpBL, TpSiL and TpC. The channels TpFL, TpFC, TpFR, TpSiR, TpBR, TpBL and TpSiL are downmixed into the two downmix signals TpFL′ and TpFR′, as shown in the sixth exemplary embodiment and in FIG. 12. From the channels TpFL′ and TpFR′ of the downmix signal, the channels TpFL, TpFC, TpFR, TpSiR, TpBR, TpBL and TpSiL of the upmix signal are determined, as shown in the sixth exemplary embodiment and in FIG. 13. The channels FL, FC, FR, BR, BL, TpBC and TpC are downmixed into the four downmix signals FL′, FR′, BL′ and BR′, as shown in the eighth exemplary embodiment and in FIG. 14. From the channels FL′, FR′, BL′ and BR′ of the downmix signal, the channels FL, FC, FR, BR, BL, TpBC and TpC of the upmix signal are determined, as shown in the eighth exemplary embodiment and in FIG. 15.

In an eleventh exemplary embodiment, a multichannel signal having k=6 channels is downmixed in a downmix apparatus into a downmix signal having m=4 channels and then upmixed again in an upmix or coding apparatus into upmix signal having n=6 channels. In this case, the multichannel signal, the downmix signal and the upmix signal may possibly also have additional channels.

FIG. 18 shows the downmix of the channels TpFL, TpFC, TpFR, TpBR, TpBL and TpC of the multichannel signal. The four channels of the downmix signal are determined as follows:

TpFL′=TpFL+0.5*TpFC

TpFR′=TpFR+0.5*TpFC

TpBL′=TpBL+0.5*TpC

TpBR′=TpBR+0.5*TpC.

This means that a top front left downmix channel TpFL′ is formed from a linear combination of the channels TpFL and TpFC, a top front right downmix channel TpFR′ is formed from a linear combination of the channels TpFR and TpFC, a top rear left downmix channel TpBL′ is formed from a linear combination of the channels TpBL and TpC, and a top rear right downmix channel TpBR′ is formed from a linear combination of the channels TpBR and TpC. The four channels of the downmix can additionally have the volume of data reduced by means of stereo masking, for example by means of USAC v2 encoding, and therefore result in two “Channel Pair Elements” (CPEs).

FIG. 19 shows the upmix of the channels TpFL, TpFC, TpFR, TpBR, TpBL and TpC of the upmix signal from the channels TpBL′, TpBR′, TpFL′ and TpFR′ of the downmix signal. In this case, the two correlation comparisons

K(TpFL′,TpFR′)→TpFC,(TpFL,TpFR)

K(TpBL′,TpBR′)→TpC,(TpBL,TpBR)

are performed, which result in the center channel TpFC and also the channels TpFL and TpFR, and the center channel UpmixCenter and also the channels TpBR and TpBL, the channel UpmixCenter being only an intermediate signal and forming the TpC of the upmix signal directly. The channels TpFR and TpFL and the channels TpBR and TpBL of the upmix signal could alternatively also be determined on the basis of TpFR′ corrected with TpFC and TpFL′ corrected with TpFC and also on the basis of TpBR′ corrected with TpBC and TpBL′ corrected with TpBC.

In a twelfth exemplary embodiment, a multichannel signal having k=11 channels is downmixed in a downmix apparatus into a downmix signal having m=8 channels and then upmixed again in an upmix or coding apparatus into upmix signal having n=11 channels. In this case, the multichannel signal, the downmix signal and the upmix signal may possibly also have additional channels. The twelfth exemplary embodiment consists of a combination of the tenth and eleventh exemplary embodiments.

In a thirteenth exemplary embodiment, a multichannel signal having k=8 channels is downmixed in a downmix apparatus into a downmix signal having m=4 channels and then upmixed again in an upmix or coding apparatus into upmix signal having n=8 channels. In this case, the multichannel signal, the downmix signal and the upmix signal may possibly also have additional channels.

FIG. 20 shows the downmix of the channels FL, FC, FR, BR, BL, TpBL, TpBR and TpC of the multichannel signal. The four channels of the downmix signal are determined as follows:

FL′=FL+0.5*FC

FR′=FR+0.5*FC

BL′=BL+0.5*TpC+0.7071*TpBL

BR′=BR+0.5*TpC+0.7071*TpBR.

This means that a front left downmix channel FL′ is formed from a linear combination of the channels FL and FC, a front right downmix channel FR′ is formed from a linear combination of the channels FR and FC, a rear left downmix channel BL′ is formed from a linear combination of the channels BL, TpBL and TpC, and a rear right downmix channel BR′ is formed from a linear combination of the channels BR, TpBR and TpC. The four channels of the downmix signal can additionally have the volume of data reduced by means of stereo masking, for example by means of USAC v2 encoding, and therefore result in two “Channel Pair Elements” (CPEs).

FIG. 21 shows the upmix of the channels FL, FC, FR, BR, BL, TpBR, TpBL and TpC of the upmix signal from the channels BL′, BR′, FL′ and FR′ of the downmix signal. In this case, the two correlation comparisons

K(FL′,FR′)→FC,(FL,FR)

K(BL′,BR′)→UpmixCenter,(BL,BR)

are first of all performed, which result in the center channel FC and also the channels Fl and FR, and the center channel UpmixCenter and also the channels BR and BL, the channel UpmixCenter being only an intermediate signal and, rather than a rear center channel (BC) of the upmix signal, forming the TpC of the upmix signal. The channels FR and FL and the channels BR and BL of the upmix signal could alternatively also be determined on the basis of FR′ corrected with FC and FL′ corrected with FC and also on the basis of BR′ corrected with UpmixCenter and BL′ corrected with UpmixCenter. Hence, a first subset of the upmix signal having the channels FR, FC, FL and also having the channels BR, BL and UpmixCenter is obtained.

The inverse coding of the channel BL with the parameter set P(TpBL) results in:

TpBL=0.7071*Inv(BL,P(TpBL)).

The inverse coding of the channel BR with the parameter set P(TpBR) results in:

TpBR=0.7071*Inv(BR,P(TpBR)).

Hence, correlation comparison obtains the channels FR, FC and FL of the upmix signal and correlation comparison of BL′ and BR′ obtains the channels BR, BL and TpC, and inverse coding obtains the channels TpBL and TpBR.

In a fourteenth exemplary embodiment, a multichannel signal having k=3 channels is downmixed in a downmix apparatus into a downmix signal having m=2 channels and subsequently upmixed again in an upmix or coding apparatus into upmix signal having n=3 channels. In this case, the multichannel signal, the downmix signal and the upmix signal may possibly also have additional channels.

FIG. 22 shows the downmix of the channels TpFL, TpFC and TpFR of the multichannel signal. The two channels of the downmix signal are determined as follows:

TpFL′=TpFL+0.5*TpFC

TpFR′=TpFR+0.5*TpFC.

This means that a top front left downmix channel TpFL′ is formed from a linear combination of the channels TpFL and TpFC and a top front right downmix channel TpFR′ is formed from a linear combination of the channels TpFR and TpFC. The two channels of the downmix signal can additionally have the volume of data reduced by means of stereo masking, for example by means of USAC v2 encoding, and therefore result in one “Channel Pair Element” (CPE).

FIG. 23 shows the upmix of the channels TpFL, TpFC and TpFR of the upmix signal from the channels TpFL′ and TpFR′ of the downmix signal. To this end, the correlation comparison

K(TpFL′,TpFR′)→TpFC,(TpFL,TpFR)

is performed, which results in the center channel TpFC and also the corner channels TpFR and TpFL. The channels TpFR and TpFL of the upmix signal could alternatively also be determined on the basis of TpFR′ corrected with TpFC and TpFL′ corrected with TpFC.

In a fifteenth exemplary embodiment, a multichannel signal having k=11 channels is downmixed in a downmix apparatus into a downmix signal having m=6 channels and subsequently upmixed again in an upmix or coding apparatus into upmix signal having n=11 channels. In this case, the multichannel signal, the downmix signal and the upmix signal may possibly also have additional channels. The fifteenth exemplary embodiment consists of a combination of the thirteenth and fourteenth exemplary embodiments.

Should the invention protected by the claims have exemplary embodiments/scopes of protection from the subsequently published WO2014/072513, then this explicitly discloses, by way of reference, that all exemplary embodiments disclosed in WO2014/072513 that fall within the scope of protection of the claims are disclosed as disclaimers. This means that the scope of protection granted by the patent claims minus the exemplary embodiments disclosed in WO2014/072513 (individually, altogether or in any combination) is known to be explicitly disclosed hereby.

Should the invention protected by the claims have exemplary embodiments/scopes of protection from the unpublished CH01727/13 and CH1696/13, then this explicitly discloses, by way of reference, that all exemplary embodiments disclosed in CH01727/13 and CH1696/13 that fall within the scope of protection of the claims are disclosed both positively as an exemplary embodiment and as a disclaimer. This means that the scope of protection granted by the patent claims can be split into the exemplary embodiments disclosed in CH01727/13 and CH1696/13 and into the exemplary embodiments/scope of protection remaining as a result of the granted scope of protection minus the exemplary embodiments disclosed in CH01727/13 and CH1696/13 (individually, altogether or in any combination).

Should the invention protected by the claims have exemplary embodiments/scopes of protection from the unpublished CH00743/14, then this explicitly discloses, by way of reference, that all exemplary embodiments disclosed in CH00743/14 that fall within the scope of protection of the claims are disclosed both positively as an exemplary embodiment and as a disclaimer. This means that the scope of protection granted by the patent claims can be split into the exemplary embodiments disclosed in CH00743/14 and into the exemplary embodiments/scope of protection remaining as a result of the granted scope of protection minus the exemplary embodiments disclosed in CH00743/14 (individually, altogether or in any combination).

Should the invention protected by the claims have exemplary embodiments/scopes of protection from the unpublished CH0369/14, then this explicitly discloses, by way of reference, that all exemplary embodiments disclosed in CH0369/14 that fall within the scope of protection of the claims are disclosed both positively as an exemplary embodiment and as a disclaimer. This means that the scope of protection granted by the patent claims can be split into the exemplary embodiments disclosed in CH0369/14 and the exemplary embodiments/scope of protection remaining as a result of the granted scope of protection minus the exemplary embodiments disclosed in CH0369/14 (individually, altogether or in any combination).

What is claimed is:

1. A method for upmixing a downmix signal having a first channel and a second channel into an upmix signal, having the steps of:
performing of a correlation comparison for determining correlated signal components of the first channel and the second channel of the downmix signal, wherein a first channel of the upmix signal is determined on the basis of the first channel of the downmix signal, a second channel of the upmix signal is determined on the basis of the second channel of the downmix signal, and a third channel of the upmix signal is determined on the basis of the correlated signal components, and
determining of at least one fourth channel of the upmix signal by means of inverse coding of the first channel, of the second channel or of the third channel of the upmix signal or by means of inverse coding of a signal that is based on the correlated signal components, the first channel of the downmix signal and/or the second channel of the downmix signal.

2. The method as claimed in claim 1, wherein the first channel, the second channel and the third channel of the upmix signal are associated with a first loudspeaker layer, and the at least one fourth channel of the upmix signal, which is associated with a loudspeaker layer adjacent to the first loudspeaker layer, is determined by means of inverse coding of the first channel, of the second channel or of the third channel of the upmix signal.

3. The method as claimed in claim 1, wherein the first channel of the upmix signal is a front left channel, the second channel of the upmix signal is a front right channel and the third channel of the upmix signal is a front center channel, and the at least one fourth channel
is a bottom front left channel from inverse coding of the front left channel of the upmix signal, or
is a bottom front center channel from inverse coding of the front center channel of the upmix signal, or
is a bottom front right channel from inverse coding of the front right channel of the upmix signal.

4. The method as claimed in claim 3, wherein the at least one fourth channel
is a bottom front left channel from inverse coding of the front left channel of the upmix signal,
a bottom front center channel is formed from inverse coding of the front center channel of the upmix signal, and
a bottom front right channel is formed from inverse coding of the front right channel of the upmix signal.

5. The method as claimed in claim 4, wherein a front center left channel of the upmix signal is formed from inverse coding of the front left channel of the upmix signal, and/or a front center right channel of the upmix signal is formed from inverse coding of the front right channel of the upmix signal, wherein different parameters are used for the inverse coding of the front left channel of the upmix signal for the front center left channel of the upmix signal and for the inverse coding of the front left channel of the upmix signal for the bottom front left channel of the upmix signal, and/or different parameters are used for the inverse coding of the front right channel of the upmix signal for the front center right channel of the upmix signal and for the inverse coding of the front right channel of the upmix signal for the bottom front right channel of the upmix signal.

6. The method as claimed in claim 3, wherein the downmix signal has a rear left channel and a rear right channel, and a rear center channel is determined from the correlated signal components of the rear left channel and the rear right channel of the downmix signal, which correlated signal components are ascertained using a correlation comparison.

7. The method as claimed in claim 6, wherein a side left channel of the upmix signal is determined on the basis of the common signal components of the first channel of the downmix signal and the rear left channel of the downmix signal by means of a correlation comparison, and/or a side right channel of the upmix signal is determined on the basis of the common signal components of the second channel of the downmix signal and the rear right channel of the downmix signal by means of a correlation comparison.

8. The method as claimed in claim 1, wherein the first channel of the upmix signal is a rear left channel, the second channel of the upmix signal is a rear right channel and the third channel of the upmix signal is a rear center channel, and the at least one fourth channel is a top rear center channel, determined from inverse coding of the rear center channel of the upmix signal.

9. The method as claimed in claim 7, wherein a top center channel is determined on the basis of the rear center channel, particularly by means of multiplication by a factor of greater than one.

10. The method as claimed in claim 1, wherein the first channel of the upmix signal is a rear left channel, the second channel of the upmix signal is a rear right channel and the at least one fourth channel
is a top rear left channel, determined from inverse coding of the rear left channel of the upmix signal or of the first channel of the downmix signal, and/or
is a top rear right channel, determined from inverse coding of the rear right channel of the upmix signal or of the second channel of the downmix signal.

11. The method as claimed in claim 10, wherein the third channel of the upmix signal is a top center channel.

12. The method as claimed in claim 1, wherein the downmix signal has a top front left channel and a top front right channel, and a top front center channel of the upmix signal is determined on the basis of the correlated signal components of the top front left channel and the top front right channel of the downmix signal, which correlated signal components are ascertained by means of a correlation comparison, a top front left channel of the upmix signal being determined on the basis of the top front left channel of the downmix signal, and/or a top front right channel of the upmix signal being determined on the basis of the top front right channel of the downmix signal.

13. The method as claimed in claim 12, wherein a top side left channel of the upmix signal is determined by means of inverse coding of the top front left channel of the downmix signal or of the upmix signal, and/or a top side right channel of the upmix signal is determined by means of inverse coding of the top front right channel of the downmix signal or of the upmix signal.

14. The method as claimed in claim 13, wherein a top rear left channel of the upmix signal is determined by means of inverse coding of the top side left channel of the upmix signal, and/or a top rear right channel of the upmix signal is determined by means of inverse coding of the top side right channel of the upmix signal.

15. The method as claimed in claim 1, wherein the first channel of the upmix signal is a front right channel, the second channel of the upmix signal is a front left channel, the third channel of the upmix signal is a front center channel and the at least one fourth channel
is a front center left channel, determined from inverse coding of the front left channel of the upmix signal, and/or
is a front center right channel, determined from inverse coding of the front right channel of the upmix signal.

16. The method as claimed in claim 1, wherein the first channel of the downmix signal is a top front right channel and the second channel of the downmix signal is a top front left channel, wherein the first channel of the upmix signal is a top front right channel, the second channel of the upmix signal is a top front left channel, the third channel of the upmix signal is a top front center channel and the at least one fourth channel a top side left channel or a top rear left channel of the upmix signal being determined by means of inverse coding of the top front left channel of the downmix signal or of the upmix signal, and/or
a top side right channel or a top rear right channel of the upmix signal being determined by means of inverse coding of the top front right channel of the downmix signal or of the upmix signal.

17. The method as claimed in claim 16, wherein a top side left channel of the upmix signal is determined by means of inverse coding of the top front left channel of the downmix signal or of the upmix signal, and/or a top side right channel of the upmix signal is determined by means of inverse coding of the top front right channel of the downmix signal or of the upmix signal.

18. The method as claimed in claim 17, wherein a top rear left channel of the upmix signal is determined by means of inverse coding of the top side left channel of the upmix signal, and/or a top rear right channel of the upmix signal is determined by means of inverse coding of the top side right channel of the upmix signal.

19-26. (canceled)

27. A non-transitory computer program designed to carry out the following steps when executed on a processor;
performing of a correlation comparison for determining correlated signal components of the first channel and the second channel of the downmix signal, wherein a first channel of the upmix signal is determined on the basis of the first channel of the downmix signal, a second channel of the upmix signal is determined on the basis of the second channel of the downmix signal, and a third channel of the upmix signal is determined on the basis of the correlated signal components, and
determining of at least one fourth channel of the upmix signal by means of inverse coding of the first channel, of the second channel or of the third channel of the upmix signal or by means of inverse coding of a signal that is based on the correlated signal components, the first channel of the downmix signal and/or the second channel of the downmix signal.

28. An apparatus for upmixing a downmix signal having a first channel and a second channel into an upmix signal, having:
correlation comparison apparatus for performing a correlation comparison for determining correlated signal components of the first channel and the second channel of the downmix signal, wherein a first channel of the upmix signal is determined on the basis of the first channel of the downmix signal, a second channel of the upmix signal is determined on the basis of the second channel of the downmix signal, and a third channel of the upmix signal is determined on the basis of the correlated signal components;
inverse coding apparatus for determining at least one fourth channel of the upmix signal by means of inverse coding of the first channel, of the second channel or of the third channel of the upmix signal or by means of inverse coding of a signal that is based on the correlated signal components, the first channel of the downmix signal and/or the second channel of the downmix signal.

29-31. (canceled)
